(19) United States
(12) Patent Application Publication
(10) Pub. No.: US 2007/0050175 A1
(43) Pub. Date: Mar. 1, 2007

(54) Content enhancement based on contextual data within a feed

(76) Inventors: Richard Schmelzer, Boulder, CO (US); Tomas Jablonski, Avon, CO (US)

Correspondence Address: COOLEY GODWARD KRONISH LLP;ATTN: PATENT GROUP, THE BOWEN BUILDING, 875 15TH STREET, N.W. SUITE 800, WASHINGTON, DC, 20005-2221, US

(21) Appl. No.: 11/455,127

(22) Filed: Jun. 16, 2006

Related U.S. Application Data
(60) Provisional application No. 60/691,030, filed on Jun. 16, 2005.

(51) Int. Cl. G06F 11/30

(52) U.S. Cl. 702/186

(57) ABSTRACT

A system and method for enhancing content feeds is described. One embodiment includes receiving a request for a content feed available from a feed provider and retrieving the content feed from the feed provider. In addition, one or more enhanced-content files that are related to the content feed are located from among a plurality of enhanced-content files. Content from one or more of the enhanced-content files is then inserted in the content feed so as to create an enhanced-content feed, and the enhanced content feed is provided to a consumer.

### PRIORITY

The present application claims priority from to commonly owned and assigned application No. 60/691,030, filed Jun. 16, 2005, Attorney Docket No. MODY-002/00US, entitled CONTENT INSERTION BASED ON CONTEXTUAL DATA WITHIN AN XML FEED, which is incorporated herein by reference.

### FIELD OF THE INVENTION

The present invention relates generally to software tools for accessing content, and more particularly to software tools for enhancing web-based content.

### BACKGROUND OF THE INVENTION

Millions of web pages are available as a source of content for users of the Internet. These web pages take many forms, including, for example, articles, blurbs, and web logs (“blogs”), among others. To facilitate dissemination of information, “feeds” have been developed as a way to publish content in a structured format that facilitates identification and analysis. A feed (also known as a “news feed” or “blog feed”) can contain items (e.g., news items), metadata (e.g., tags) about the articles (e.g., title, date, and author), and/or metadata about the feed itself (e.g., title, URL, and last-updated timestamp). Some feeds are described by Resource Description Framework (RDF) statements and/or encoded using eXtended Markup Language (XML) (such as, e.g., the XML syntax RDF/XML, RSS, Atom). These features of feeds make it easier for applications to automatically collect and evaluate content for presentation to the user.

The term “syndication XML” refers to XML that has been developed for feeds, such as Atom and RSS (“Really Simple Syndication,” “Rich Site Summary,” or “RDF Site Summary”). Since the general structure of a feed is known, it is possible to identify the news content within it. Software applications have been developed that work with content published using syndication XML.

Although feeds have made it easier to access content, the content presented in the feed is often aesthetically one-dimensional because feed providers may not have the resources and/or desire to incorporate additional content into their feeds. In addition, many feed providers are unable to track usage of links in their feeds, and as a consequence, are unable to determine how effective or popular the content distributed by their feed is. Moreover, many feed providers do not have a viable avenue for obtaining revenue (e.g., from advertisers) in connection with making content available with their feeds. In short, present systems are functional, but they are not sufficiently efficient or otherwise satisfactory. Accordingly, a system and method are needed to address the shortfalls of present technology and to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a system and method for enhancing content feeds. One embodiment includes receiving a request for a content feed that is made available from a feed provider and retrieving the content feed from the feed provider. In addition, one or more enhanced-content files that are related to the content feed are located from among a plurality of enhanced-content files. Content from one or more of the enhanced-content files is then merged with the content feed so as to create an enhanced-content feed, and the enhanced content feed is provided to a consumer.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a block diagram depicting an environment in which embodiments of the present invention may be implemented;

FIG. 2 is a block diagram depicting an exemplary embodiment of the datastore depicted in FIG. 1;

FIG. 3 is an exemplary embodiment of the feed enhancement server depicted in FIG. 1; and

FIG. 4 is a flowchart depicting a method in accordance with exemplary embodiments of the present invention.

### DETAILED DESCRIPTION

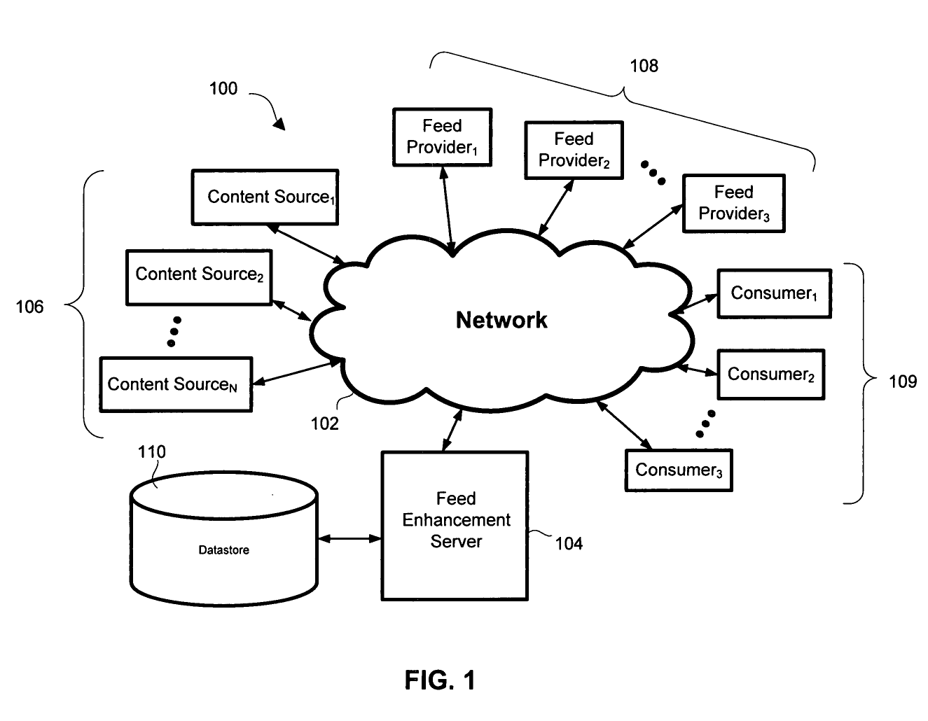

Referring now to the drawings, where like or similar elements are designated with identical reference numerals throughout the several views, and referring in particular to FIG. 1, shown is a block diagram depicting an environment 100 in which several embodiments may be utilized to enhance content feeds from feed providers.

As shown, a feed enhancement server 104 is coupled to a datastore 110 and a network 102 couples the feed enhancement server 104 to N content sources 106, N feed providers 108, and N consumers 109. The feed enhancement server 104 in several embodiments is realized by a combination of software and hardware. In many embodiments, for example, the feed enhancement server 104 is implemented by software executed by a general purpose computer to effectuate functions described further herein.

In general, the feed enhancement server 104 combines content from one or more of the content sources 106 with feeds from the feed publishers 108 in order to provide enhanced-content feeds to consumers 109. Although the feed enhancement server 104 in this embodiment is depicted as being separately located from the content sources 106 and feed providers 108, in other embodiments the feed enhancement server 104 may be implemented at any one of the locations of the content sources 106, feed publishers 108 or a consumer location. In yet other embodiments a feed provider, content source and the feed enhancement server 104 may be collocated and operated, for example, by a single business entity. The consumers may be individual users that use either a web-based feed viewer or a client-side reader, or in some embodiments may be content aggregators.

The network 102 in several embodiments includes the Internet and may also include wide area networks and local area networks as well. The content sources 106 in the exemplary embodiment are sources of content, which may include images, video, audio, and textual content. In some embodiments for example, the content sources 106 may provide advertising content, but this is certainly not required.

The feed publishers 108 in this embodiment are web sites that make content (e.g., text, audio and/or video content) available via feeds, which may be XML, RSS, RDF, Atom, HTML, Word, PDF or any other type of feed that may be parsed. Each of the consumers 109 may be users coupled to the network 102 by any one of a variety of Internet enabled devices including desktop and laptop computers, personal digital assistants (PDAs) and cellular handsets. In the exemplary embodiment, the consumers 109 receive enhanced-content feeds from the feed enhancement server 104, but from the perspective of the consumers 109, it may appear as though the enhanced-content feeds are being received directly from a feed provider.

As described further herein, the feed enhancement server 104 is configured to receive and store content from the content sources 106 in the data store. As depicted in the exemplary embodiment of FIG. 1, when a consumer accesses a feed provided by a feed publisher 108 (e.g., by entering a feed publisher's URL in a web browser), in a manner that is substantially transparent to the consumer, the consumer is routed to the feed enhancement server 104, and the enhancement server 104 retrieves the content feed from the feed publisher and generates an enhanced-content feed that includes content from the datastore 110 and the content feed from the feed publisher. The feed enhancement server 104 then provides the enhanced-content feed to the consumer. In many variations for example, the feed enhancement server 104 selectively retrieves content from the datastore that relates to subject matter of the content feed so that the enhanced-content feed has a unified theme or subject.

Beneficially, the feed publishers 108 may utilize the feed enhancement server 104 to enrich the presentation of their feeds without having to maintain their own collection of content. For example, a feed publisher that provides news feeds may desire to have images that relate to the subject of news stories incorporated into their feeds to improve the appeal of their feeds to consumers.

Moreover, the exemplary embodiment may be used as a means for the feed providers 108 to receive revenue by allowing advertising content from the content sources 106 to be merged with their content feeds. Concomitantly, advertisers may benefit from the exposure of their product or service in connection with related content (e.g., news content) that the consumer is interested in. As discussed further herein, the feed enhancement server 104 may also enhance a content feed by placing one or more tracking mechanisms in the enhanced-content feed. Consequently, the feed enhancement server 104 may also track information about the number of consumers that access particular feeds as well as information about consumers that access advertising content in the enhanced-content feeds.

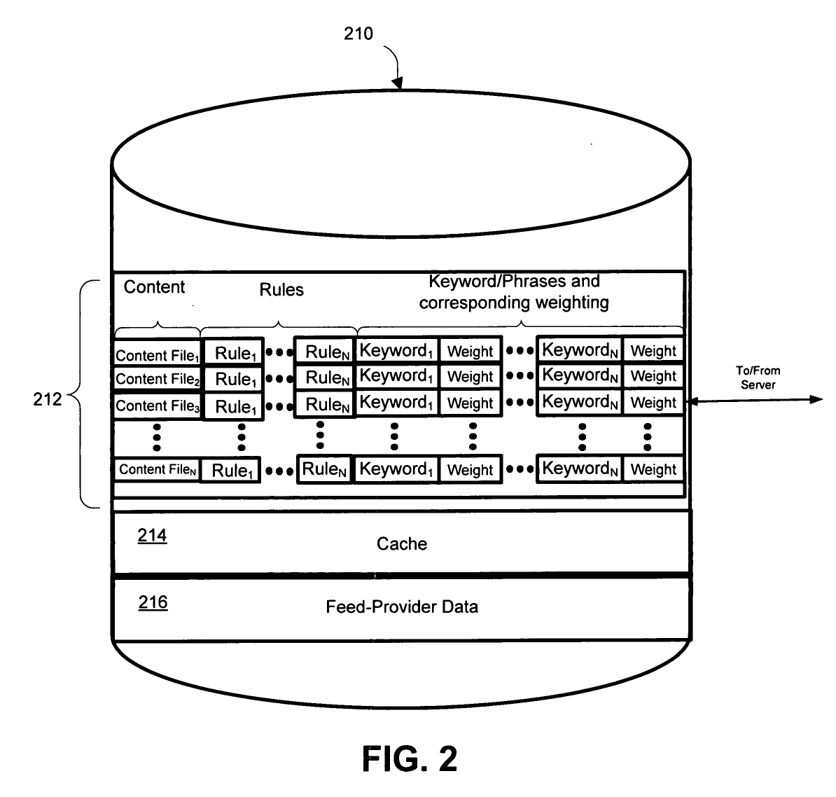

Referring next to FIG. 2, shown is one embodiment of the datastore 110 depicted in FIG. 1. As depicted, the datastore 210 in this embodiment includes a content datastore 212, a cache 214 and a feed-provider datastore 216. As shown, the content data store 212 includes N content files, and stored in connection with each of the content files is a set of N rules and a collection of N keywords and/or phrases that are associated with content of the corresponding content file. As used herein the term keywords may include, for example, words from an abstract, title or tags that are associated with the content, and the content files may be any type of files, which could include images, audio, video or text. In addition, the content in the files may have a URL or click through reference associated with the content to enable additional information relating to the content to be obtained. In some implementations, for example, purchasing or licensing information may be available via a URL or click through reference in the content.

Although the rules depicted in FIG. 2 are not required, they allow control over how the content files are utilized. The rules may, for example, include temporal rules that designate a time frame in which a content file may be utilized; geographic rules that restrict the geographic locations in which the content may be distributed; rules that dictate the form that the content may be distributed in (e.g., text, audio, video); and rules that govern the feed providers that the content may or may not be used in connection with (e.g., CBS may require their content not be used in connection with ABC content feeds or an article containing media property of ABC or even mentioning ABC).

As shown, each of the keywords and/or phrases may have a weight associated with them based upon a relevance of the word or phrase. As an example, a content file may include a “Britney Spears” calendar and potential keywords associated with the calendar could be: “Britney,” “Spears,” “Britney Spears,” “calendar”, “Zomba Records,” “teen idols,” “Kevin Federline,” “Not to Innocent,” “pop diva,” etc. The weighting may be automated or it may be manually performed. As discussed further herein, proper nouns such as names, places and events may be given a greater weight that other words that may be less suggestive of the subject matter of the content file. The content files may be input manually or through an automated process using a crawler or Screen Scraper or a file transfer from the content sources 106.

The cache 214 in this embodiment enables both content feeds and enhanced content feeds to be stored so as to be quickly retrievable in the event a content feed or enhanced content feed is requested more than once. The original content feed (e.g., un-enhanced) may be stored so that the feed enhancement server 104 retains flexibility as to the particular content from the content datastore 112 that will be merged with the original content feed. For example, if a rule precludes using content that was merged into a cached enhanced-content feed (e.g., because a geographic restriction) the original content feed is available to be merged with content from another content file.

The feed-provider data 216 may include data relating to use of enhanced-content feeds. In some embodiments, the feed-provider data 216 includes data relating to each of the enhanced-content feeds for each feed provider that uses the feed enhancement server 104. For example, the feed-provider data 216 may include, without limitation, data about the number of consumers that subscribe to a feed (e.g., both active and inactive subscribers); the number of times a URL or click-through reference in an enhanced-content portion (e.g., advertisement portion) of the enhanced-content feed is used; the number of times each story is viewed; the number of times each page is viewed; and the number of clicks on a complete story.

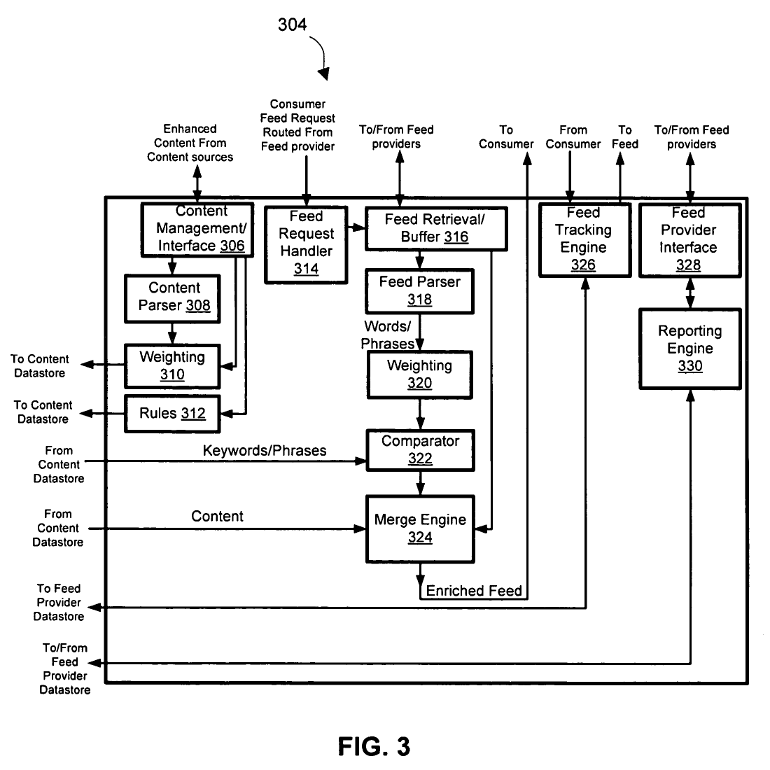

Referring next to FIG. 3, shown is a block diagram of one embodiment of the feed enhancement server 104 of FIG. 1. As shown, the feed enhancement server 304 in this embodiment includes a content management interface 306 that is coupled to a content parser 308, a content weighting module 310 and a rules module 312. In addition, a feed request handler 314 is shown coupled to a feed retrieval module 316 that is coupled to a merge engine 324 and a comparator 322 via a feed parser 318 and a weighting module 320. In addition, the feed enhancement server 304 includes a feed tracking engine 326 and a feed provider interface 328 that is coupled to a reporting engine 330. The illustrated arrangement of these components is logical and not meant to be an actual hardware diagram. Thus, the components can be combined or further separated in an actual implementation. Moreover, the construction of each individual component is well-known to those of skill in the art.

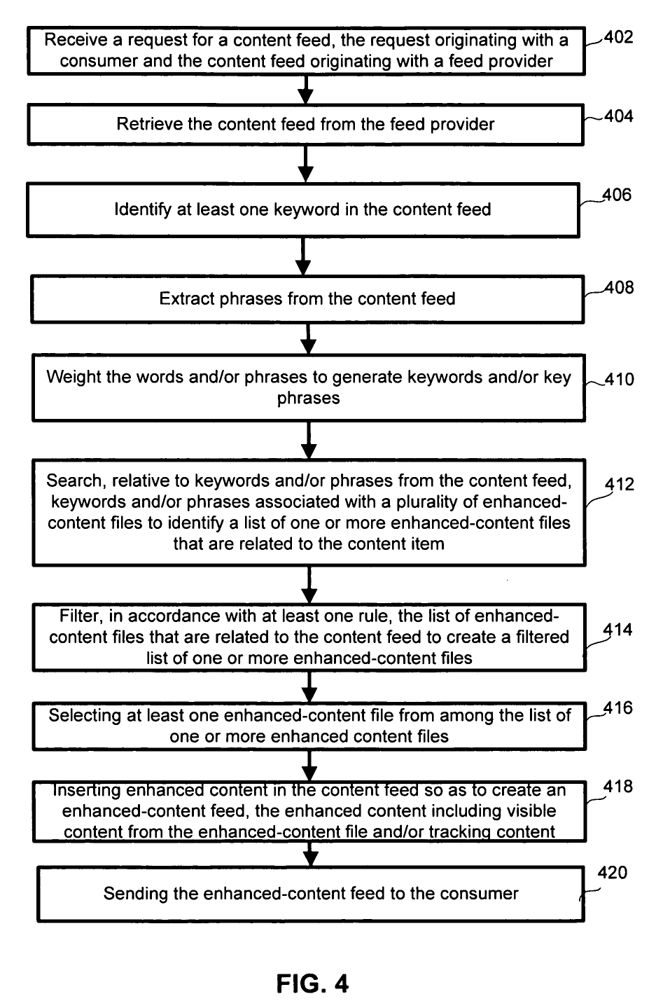

While referring to FIG. 3, simultaneous reference will be made to FIG. 2 and FIG. 4, which is a flowchart depicting an exemplary method that may be carried out in accordance with the embodiments depicted in FIGS. 2 and 3. It should be recognized, however, that the method depicted in FIG. 4 is certainly adaptable to embodiments other than those of FIGS. 2 and 3. As shown in FIG. 3, the content management interface 306 is disposed to provide an interface for content sources (e.g., the content sources 106) and may be realized by a web page server configured to receive content from the content sources and provide user interfaces for content sources to upload content to the content datastore 212.

The content parser 308 in this embodiment is configured to parse through content and provide a list of keywords (e.g., tags), which are weighted by the content weighting module 310 based upon predefined rules. For example, less relevant words such as prepositions are given less weight while proper nouns and selected phrases are given more weight. The content parser 308 is certainly not required, however, and keywords and phrases may be provide by the content sources or established by personnel managing the feed enhancement server 304. As depicted in FIG. 3, in some embodiments content sources are able to access the weighting module 310 via the content management interface in order to customize the weighting of particular words or phrases in the content. In addition, the content management interface 310 in this embodiment enables content sources to interact with the rule engine 312 to establish or modify the rules associated with their content.

In many instances, the enhanced content from content sources may be deliberately parsed through by personnel for keywords and phrases before it is added to the datastore 212. In contrast, content feeds from feed providers may change more frequently than the content from content sources and there is little or no time for a manual parsing of content feeds. As a consequence, in some variations, key phrases are identified in the stored content, and then the content feeds are searched to identify any matching phrases.

In addition to the content management interface 306, the feed enhancement server 304 also includes a feed provider interface 328, which is configured to enable feed providers (e.g., the feed providers 108) to interact with the enhancement server 304 and the feed-provider datastore 216. Although not required, the feed provider interface may be realized by a web page server that provides interfaces for the feed provider to interact (e.g., obtain or provide information) with the enhanced server 304.

In some embodiments for example, the feed-provider datastore 216 may include data relating to each of the feed providers. As described further herein, the feed-provider datastore 216 may include information about usage of each feed provider's content feeds. In addition, in some variations, the enhanced server 304 may be adapted to enable each feed provider to enter into an agreement (e.g., a subscription agreement) with an operator of the enhancement server 304 and account information for each feed provider may be stored and made accessible to each corresponding feed provider.

The reporting engine 330 in this embodiment is configured to retrieve the various types of information (e.g., account and feed-usage information) from the feed-provider datastore 216 and may be configured to enable feed providers to generate specific queries for data in the feed-provider datastore 216.

In several implementations, when a feed provider desires to enhance their content feeds using the enhanced content server 304, the feed provider either includes a reference to the enhanced content server 304 when creating a new feed, or alternatively, the feed provider may continue to use an existing URL (e.g., that consumers are familiar with) and redirect consumers to the enhanced content server 304.

As an example, assuming the enhanced content server 304 is accessible via “run.Modya.com/injexion/process.php?name=your company_name&URL=,” the feed provider may create a new URL, which includes the feed provider's URL concatenated with the enhanced content server's URL. For example, a feed provider at www.feedprovider.com creating a new feed named my_feed may create a new URL as: run.Modya.com/injexion/process.php?name=your_company_name&url=www.feedprovider/my_feed.xml. This method is best for new feeds, because it requires the consumers to enter a new feed URL into their readers.

A second, slightly more complicated method, is appropriate for popular pre-existing feeds, because it does not introduce a new URL to the clients. The below explanation assumes that a feed provider's existing feed URL is: http://www.feedprovider.com/my_feed.xml. In this case, the feed provider moves the existing feed location (file or path name) to a new one. For example, if the feed's file name was my_feed.xml, it may be renamed to feed_injexion.xml, and redirection on the feed provider's web server may be activated by forwarding users coming to the old URL to the new one. The new URL will be: run.modya.com/injexion/process.php?name=your_company_name&url=http://www.feedprovider.com/my_feed_injexion.xml.

The exact details of activating redirection differ for various web server environments, but are well known to those of ordinary skill in the art. For example, for Apache servers, the following line may be added to the configuration file (usually httpd.conf): Redirect /my_feed.xml run.modya.com/injexion/process.php?name=your_company_name&url=http://www.feedprovider.com/feed_injexion.xml.

Referring to FIG. 4, once the content datastore 212 includes content (also referred to herein as enhanced content) and a feed provider has adapted their feeds as discussed above, the enhanced content server 304 is able to receive a request at the feed request handler 314 for a content feed, and in response, the feed retrieval module 316 retrieves and buffers the content feed from the feed provider so that the feed parser 318 may parse the content feed and identify keywords (Blocks 402, 404, 406). As depicted in FIG. 4, in some embodiments phrases are also extracted from the content feed by the feed parser (Block 408). In other embodiments, however, only keywords are identified in order to expedite processing of the content feed.

As shown in FIG. 4, the weighting module 320 then weights the keywords and/or phrases that are identified in the content feed (Block 410). The weighting of the keywords and phrases may be carried out according to predefined weighting rules. For example, less relevant words such as prepositions may be identified and given less weight while proper nouns may be weighted more heavily.

Once the keywords and/or phrases are weighted, the comparator 322 accesses the content datastore 212 and searches, relative to the weighted keywords and/or phrases from the content feed, the weighted keywords and phrases in the datastore 212 to identify and create a list one or more potential enhanced-content files that are related to the content item (Block 412). Based upon the weights of the keywords/phrases that match, the list of potential enhanced-content files may be sorted in terms of the strength of the match. In addition, although not required, in many embodiments the list of potential enhanced-content items is filtered by one or more rules that may be associated with each content item (Block 414).

For example, if a rule associated with a particular enhanced-content file requires that the enhanced-content file not be utilized after a certain date that has already passed, that particular enhanced-content file is filtered out of the list of potential enhanced-content files. As another example, if a rule restricts the particular enhanced-content file to use only in certain geographic locations (e.g., identified by zip code) and the request from the consumer is not coming from one of those geographic locations, the particular enhanced-content file is filtered out of the list of potential enhanced-content files.

After filtering, the merge engine 416 selects at least one enhanced-content file from among the list of remaining enhanced-content files (Block 416), and enhanced content, including content from the selected enhanced-content file, is merged with the content feed to create an enhanced-content feed (Block 418), which is then sent to the consumer (Block 420). In many embodiments, before the enhanced-content is merged with the content feed, the content feed is broken down into its constituent elements and the enhanced-content is recombined with elements of the content feed to create a unitary and integral enhanced-content feed (e.g., a single XML feed). As a consequence, when viewed by a reader, the enhanced-content feed appears as a single piece of content, which may include text, video or images.

In many embodiments, once merged, the enhanced-content is substantially inseparable from the enhanced-content feed. In particular, as opposed to prior art techniques for merely embedding a link to remotely located content within a feed, in accordance with many embodiments, the enhanced-content is itself within the enhanced-content feed. As a consequence, after the enhanced-content feed is presented to a consumer, the enhanced-content portion of enhanced-content feed is still available even when the consumer is completely uncoupled from a network (e.g., the network 102).

Beneficially, by combining the enhanced-content and content feed into a new enhanced-content feed, the enhanced content will appear to automated-processing systems to be indistinguishable from the original content feed; thus much less likely to be parsed from the enhanced-content feed and more likely to persist regardless of the type of device (e.g., mobile handset, reader, portal etc.) the consumer is using.

In addition to merging enhanced-content into the content feed, tracking content may also be merged with the content feed. Or in alternative embodiments, only tracking content may be merged with the content feed. In one implementation, the tracking content may include a reference back to feed tracking engine 326 within one or more links in the enhanced content feed so that when a consumer follows a link in the enhanced-content feed, the consumer is linked to the feed tracking engine before being routed to the ultimate destination identified by the link. The tracking engine 326 may then store the information about the use of the enhanced-content feed in the feed-provider datastore 216.

In addition to, or instead of, enhancing a link of the content feed, tracking content in the form of a substantially invisible picture (e.g., a single pixel) that is hosted by the feed tracking engine 326 may be inserted into one or more portions of the content feed. In this way, when a consumer views a page that includes the substantially invisible picture, the feed tracking engine 326 is accessed to retrieve the picture and the feed tracking engine 326 may then make an entry in the feed-provider data 216 that indicates the page was viewed.

In conclusion, the present invention provides, among other things, a system and method for enhancing content feeds. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for enhancing a content feed comprising:
receiving a request for the content feed, the request originating with a consumer and the content feed originating with a feed provider;
retrieving the content feed from the feed provider;
locating, from among a plurality of enhanced-content files, one or more enhanced-content files that are related to the content feed;
selecting at least one enhanced-content file from among the one or more enhanced content files, the selecting based upon at least one rule, the at least one rule limiting use of the one or more enhanced-content files;
inserting enhanced content in the content feed so as to create an enhanced-content feed, the enhanced content including content from the at least one enhanced-content file; and
presenting the enhanced-content feed to the consumer.

2. The method of claim 1, wherein the locating includes comparing at least one keyword from the content feed with keywords from corresponding ones of the plurality of enhanced-content files.

3. The method of claim 2 including:
receiving, in connection with the content feed, the at least one keyword.

4. The method of claim 2 including:
searching through words associated with the content feed; and
selecting at least one keyword from among the words of the content feed.

5. The method of claim 4, wherein the keywords include including:
searching through words of the content feed; and
selecting at least one keyword from among tags associated with the content feed.

6. The method of claim 4, wherein the selecting includes selecting the at least one keyword based upon a weight of the keyword, wherein the weight is based upon factors selected from the group consisting of: whether the at least one keyword is in a title of the content feed, whether the keyword is a proper noun, a frequency of the at least one keyword in the content feed.

7. The method of claim 1, wherein the plurality of enhanced-content files are advertisements.

8. The method of claim 1, wherein each of the enhanced-content files include content selected from the group consisting of images, audio, video and text.

9. The method of claim 1, wherein the at least one rule limits use of the one or more enhanced-content files based upon the feed provider.

10. The method of claim 1, wherein the at least one rule limits use of the one or more enhanced-content files based upon the location of the consumer.

11. The method of claim 1, wherein the at least one rule places a temporal limitation upon use of the one or more enhanced-content files.

12. The method of claim 1, wherein the content feed is formatted in accordance with a format selected from the group consisting of XML, RSS, RDF, Atom, HTML, Word and PDF.

13. The method of claim 1, wherein the content feed includes content selected from the group consisting of text, audio and video content.

14. The method of claim 1, wherein inserting enhanced content in the content feed includes inserting tracking content in the content feed, wherein the tracking content enables information about a number of consumers accessing the content feed to be tracked.

15. The method of claim 14, wherein inserting tracking content includes replacing a link in the content feed with another link pointing to a tracking server.

16. The method of claim 14, wherein inserting tracking content includes inserting a substantially-invisible picture in the content feed, the substantially-invisible picture being hosted by a tracking server.

17. A system for enhancing content feeds from a feed provider comprising:
a content datastore, the content datastore including a plurality of enhanced-content files and a plurality of keywords, each of the plurality of enhanced-content files being associated with a corresponding one of the plurality of keywords;
a content feed request handler, the feed request handler being configured to receive a request for a content feed;
a comparator module configured to compare at least one keyword associated with the content feed with the plurality of keywords; and
a merge engine configured to merge the content feed with content from at least one of the plurality of enhanced-content files in response to the at least one keyword associated with the content feed matching a keyword associated with the at least one of the plurality of enhanced-content files.

18. The system of claim 17, wherein the content datastore includes at least one rule stored in connection with each of at least a portion of the enhanced-content files, the at least one rule limiting use of each of the at least a portion of the enhanced-content files.

19. The system of claim 18, wherein the at least one rule limits use of each of the at least a portion of the enhanced-content files based upon a feed provider that originates the content feed.

20. The system of claim 18, wherein the at least one rule limits use of each of the at least a portion of the enhanced-content files based upon a location of a consumer making the request for the content feed.

21. The system of claim 18, wherein the at least one rule places a temporal limitation upon use of each of the at least a portion of the enhanced-content files.

22. The system of claim 17 including:
a feed parser configured to parse the content feed into words and establish the at least one keyword associated with the content feed.

23. The system of claim 17, wherein the merge engine is configured to merge the content feed with tracking content, the tracking content enabling information about a number of consumers accessing the content feed to be tracked.

24. The system of claim 23 including:
a tracking engine configured to receive an indication that the enhanced feed has been accessed.

25. The system of claim 24, wherein the merger engine is configured to replace a link in the content feed with another link pointing to the tracking engine.

26. The system of claim 24, wherein the merger engine is configured to merge the content feed with a substantially-invisible picture, wherein the tracking engine is configured to serve up the substantially-invisible picture.

27. The system of claim 24 including:
a feed-provider data store configured to store information relative to the content feed; and
a feed-provider interface, the feed provider interface being configured to enable the feed provider to access the feed-provider datastore.
